(19) United States
(12) Patent Application Publication
(10) Pub. No.: US 2026/0300010 A1
(43) Pub. Date: Oct. 1, 2026

(54) OPTIMIZED TASK ALLOCATION AND NEGOTIATION SYSTEM

(71) Applicant: Dell Products L.P., Round Rock, TX (US)

(72) Inventors: Zijia Wang, London (GB); Mustafa Al-Bado, Cork (IE); Min Gong, Shanghai (CN)

(21) Appl. No.: 19/095,282

(22) Filed: Mar. 31, 2025

(51) Int. Cl. G06F 9/50

(52) U.S. Cl. CPC G06F 9/5027

(57) ABSTRACT

The embodiments disclosed herein include generating an initial task allocation for a first agent from a set of tasks, specifying which tasks the agent should perform. The embodiments further include predicting potential objections and counteroffer proposals from the agent in response to this allocation. A negotiation tree is then created to outline possible negotiation paths based on these predictions. The embodiments determine an optimal negotiation path that minimizes the cost for the first agent and other agents when executing the tasks. Finally, a revised task allocation for the first agent is generated based on the cost-minimizing negotiation path. This approach facilitates efficient task distribution among agents by anticipating negotiation dynamics and optimizing task assignments to reduce overall costs.

### TECHNOLOGICAL FIELD OF THE DISCLOSURE

Embodiments disclosed herein generally relate to task allocation. More particularly, at least some embodiments relate to systems, hardware, software, computer-readable media, and methods for an optimized task allocation and negotiation system.

### BACKGROUND

In complex task allocation environments, traditional methods of task allocation often fail to balance individual agent costs and overall team performance, leading to inefficiencies and dissatisfaction. Existing methods of task allocation typically overlook real-time contextual factors, focus static task allocation, and lack the transparency needed for effective negotiation and conflict resolution, thus often leading to a lack of transparency and fairness. In particular, such methods at best optimize overall team performance, but neglect individual agent costs, leading to potential inefficiencies and dissatisfaction.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a task allocation and negotiation system according to the embodiments disclosed herein.

FIG. 2 discloses aspects of an allocation initialization module according to the embodiments disclosed herein.

FIG. 3 discloses aspects of an objection forecasting module according to the embodiments disclosed herein.

FIGS. 4A and 4B disclose aspects of a negotiation mapping module according to the embodiments disclosed herein.

FIG. 5 discloses aspects of an equilibrium allocation resolution module according to the embodiments disclosed herein.

FIGS. 6A and 6B disclose aspects of a counteroffer validation and response module according to the embodiments disclosed herein.

FIGS. 7A and 7B disclose aspects of a transparent explanation synthesis module according to the embodiments disclosed herein.

FIG. 8 discloses aspects of a method according to the embodiments disclosed herein.

FIG. 9 discloses a computing entity configured and operable to perform any of the disclosed methods, processes, and operations.

### DETAILED DESCRIPTION OF SOME EXAMPLE EMBODIMENTS

Embodiments disclosed herein generally relate to task allocation. More particularly, at least some embodiments relate to systems, hardware, software, computer-readable media, and methods for an optimized task allocation and negotiation system.

In some aspects, the embodiments described herein relate to a method, including: generating from a set of tasks a first task allocation for a first agent of a set of agents, the first task allocation specifying which tasks of the set of tasks the first agent is to perform; determining one or more predicted objections and one or more predicted first counteroffer proposals of the first agent in response to the first task allocation; generating a negotiation tree that outlines potential negotiation paths based on the one or more predicted objections and one or more predicted first counteroffer proposals; determining a negotiation path of the potential negotiation paths that minimizes a first cost of the first agent and other agents of the set of agents when performing the set of tasks; and generating a second task allocation for the first agent based on the negotiation path that minimizes the cost.

In some aspects, the embodiments described herein relate to a non-transitory storage medium having stored therein instructions that are executable by one or more hardware processors to perform operations including: generating from a set of tasks a first task allocation for a first agent of a set of agents, the first task allocation specifying which tasks of the set of tasks the first agent is to perform; determining one or more predicted objections and one or more predicted first counteroffer proposals of the first agent in response to the first task allocation; generating a negotiation tree that outlines potential negotiation paths based on the one or more predicted objections and one or more predicted first counteroffer proposals; determining a negotiation path of the potential negotiation paths that minimizes a first cost of the first agent and other agents of the set of agents when performing the set of tasks; and generating a second task allocation for the first agent based on the negotiation path that minimizes the cost.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

At least some of the embodiments disclosed herein may implement one or more machine learning models. As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

The embodiments disclosed herein provide for a novel framework that addresses the shortcomings of previous task allocation methods by integrating dynamic contextual factors and real-time feedback mechanisms. A dynamic weighting system adapts the balance between individual agent costs and overall team performance based on real-time contextual factors such as task complexity, deadlines, and agent capabilities. Traditional task allocation methods often rely on static criteria for task allocation, leading to inefficiencies when conditions change. The embodiments disclosed here provide for a more responsive and optimized allocation that better meets both individual and team objectives.

The embodiments disclosed herein provide for sentiment-driven forecasting to anticipate potential objections from agents by leveraging historical interaction data and sentiment analysis. Unlike previous task allocation methods that react to objections after they occur, the embodiments disclosed herein proactively identify and mitigate conflicts before they disrupt the task allocation process, improving overall system stability and agent satisfaction.

The embodiments disclosed herein provide for an adaptive path pruning mechanism that reduces the complexity of a negotiation tree by focusing on the most probable and relevant paths. Traditional negotiation-based task allocation methods often suffer from exponential growth in complexity, making them impractical for large-scale applications. The embodiments disclosed herein streamlines the negotiation process, making it more efficient without sacrificing optimality.

The embodiments disclosed herein provide for an interactive explanation interface that allows agents to explore the reasoning behind task allocations, including the comparison of original allocations with counteroffer proposals. Traditional task allocation methods often lack transparency, leading to mistrust and dissatisfaction among agents. The embodiments disclosed herein enhances trust and understanding by providing clear, contrastive explanations that are easily accessible through an interactive interface.

In particular, the embodiments disclosed herein provide for an optimized task allocation and negotiation system that integrates multiple innovative modules to address the key challenges in multiagent task allocation. The optimized task allocation and negotiation system is designed to dynamically optimize task distribution among agents while ensuring transparency, fairness, and real-time adaptability. In at least some embodiments, the optimized task allocation and negotiation system is composed of six core modules, each contributing to a comprehensive approach that balances individual agent costs with overall team performance, anticipates objections, simplifies negotiation processes, and provides transparent explanations.

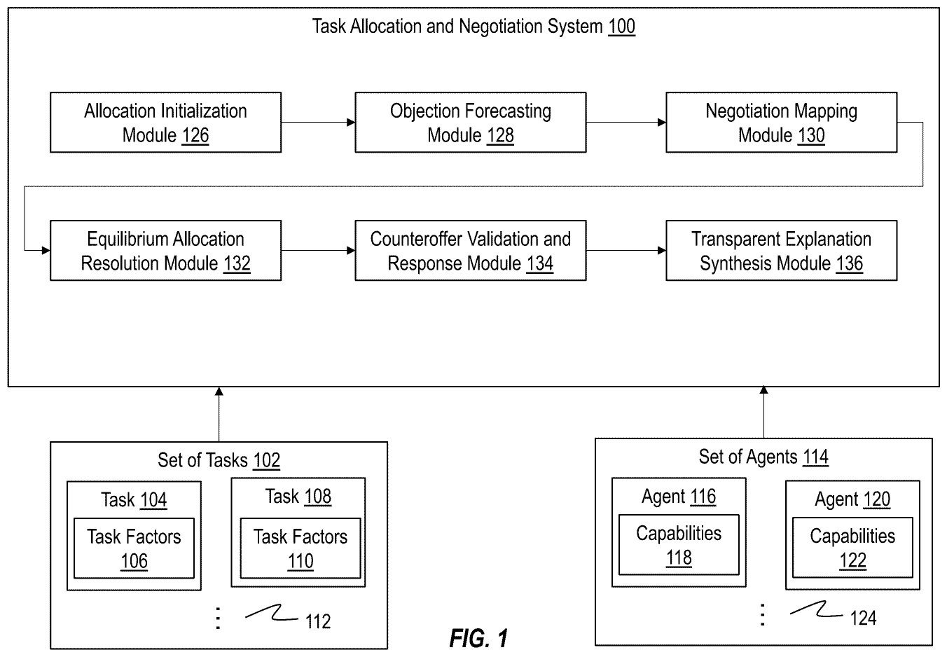

FIG. 1 illustrates an embodiment of a task allocation and negotiation system 100. In operation, the task allocation and negotiation system 100 receives or otherwise accesses a set of tasks 102 that are to be completed by two or more agents to complete an overall project or the like. For example, the set of tasks 102 can include the various coding tasks needed to be performed by two or more human agents when working on an overall software program or various manufacturing tasks needed to be performed by two or more human agents when working on an overall manufacturing task. In the case that the two or more agents are computing resources such as a CPU or GPU, the set of tasks 102 can include various computing tasks needed to be performed to complete a processing workload.

As illustrated, the set of tasks 102 includes a task 104, a task 108, and any number of additional tasks 112 as illustrated by the ellipses. Each of the tasks in the set of tasks 102 include task factors that describe parameters of the task such as, but not limited to, the complexity of the task, the estimated time it will take to complete the task, and/or the deadline the task needs to be completed by. As illustrated, the task 104 includes task factors 106 and the task 108 includes task factors 110. Although not illustrated, the additional tasks 112 include task factors.

The task allocation and negotiation system 100 also receives or otherwise accesses a set of agents 114 who are to complete the set of tasks 102. For example, the set of agents 114 includes an agent 116, an agent 120, and any number of additional agents 124 as illustrated by the ellipses. In some embodiments, the agents 116, 120, and 124 can be human agents and in other embodiments can be computing resources such as a CPU or GPU.

Each of the agents has associated agent capabilities that specify information about the agent. For example, the agent 116 is associated with capabilities 118 and the agent 120 is associated with capabilities 122. Although not illustrated, the additional agents 124 are also associated with agent capabilities. In embodiments where agents 116, 120, and 124 are human agents, the capabilities 118 and 122 can include, but are not limited to, information about the agent's experience in handling tasks similar to the set of tasks 102 and/or information about the of the agent's availability based on current workload or planned time off. In embodiments where agents 116, 120, and 124 are computing resources such as a CPU or GPU, the capabilities 118 and 122 can include, but not be limited to, information about the current workload and/or processing speeds of the CPU or GPU.

As illustrated, the task allocation and negotiation system 100 includes various modules that are used to perform the dynamic task allocation and negotiation as will be explained in more detail. It will be appreciated that the various modules of the task allocation and negotiation system 100 can be implemented as software or hardware or a combination of both. In addition, one or more of the modules can be implemented as or include one or more machine-learning (ML) or artificial intelligence (AI) models. Further, the various modules can be included on one computing system or can be distributed across multiple computing systems as circumstances warrant.

The task allocation and negotiation system 100 includes an allocation initialization module 126 that in operation is responsible for the initial distribution of tasks 104, 108, and 112 among agents 116, 120, and 124. An objection forecasting module 128 anticipates potential objections from agents 116, 120, and 124. A negotiation mapping module 130 is responsible for constructing a negotiation tree that outlines potential negotiation paths based on agents 116, 120, and 124 predicted objections and predicted counteroffers. An equilibrium allocation resolution module 132 determines the optimal task allocation that will satisfy all agents involved. A counteroffer validation and response module 134 is responsible for evaluating and responding to counteroffer or counterfactual proposals from agents 116, 120, and 124. A transparent explanation synthesis module 136 provides agents 116, 120, and 124 with clear and comprehensible explanations for the final task allocation. Each of the modules of the optimized task allocation and negotiation system 100 will be described in more detail to follow.

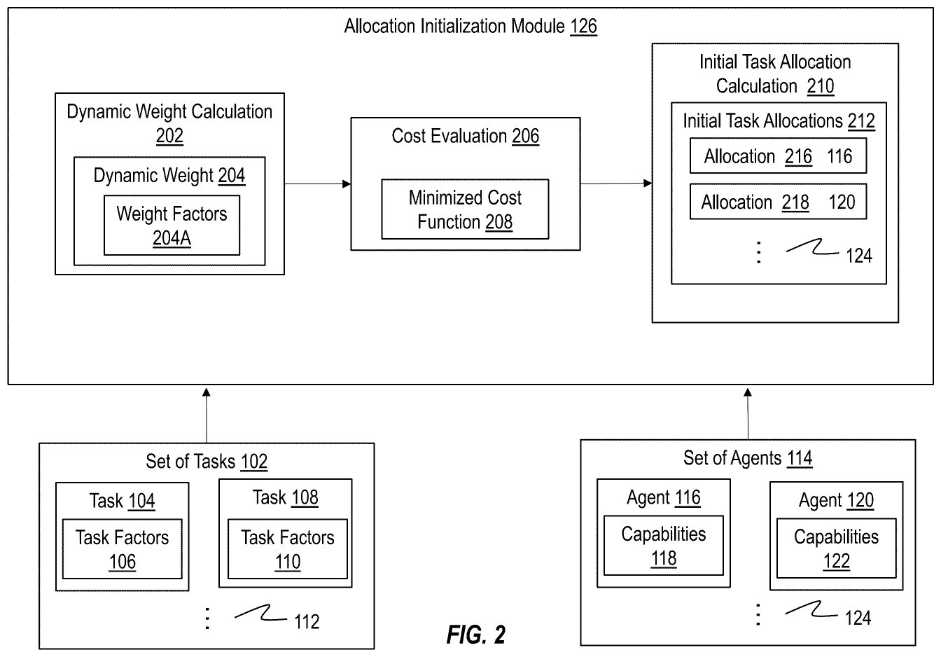

FIG. 2 illustrates an embodiment of the allocation initialization module 126 and its operation. As illustrated, the allocation initialization module 126 receives or otherwise accesses the set of tasks 102 and the set of agents 114. The allocation initialization module 126 performs a dynamic weight calculation 202 to produce a dynamic weight 204. In some embodiments, the dynamic weight 204 is determined by varying one or more weight factors 204A. The weight factors 204A are based on the task factors such as task complexity and time to complete and/or the agent capabilities.

The allocation initialization module 126 performs a cost evaluation 206 for each agent that determines the effort, time, and resources required by each of the agents 116, 120, and 124 to perform a given task 104, 108, and/or 112. The dynamic weight 204 is then used in conjunction with the cost evaluation to determine a minimized cost function 208 that specifies the minimum cost for each of the agents 116, 120, and 124 to perform a given task 104, 108, and/or 112.

Based on the minimized cost function 208, the allocation initialization module 126 performs an initial task allocation calculation 210 to generate initial task allocations 212 for each of the agents. For example, an initial task allocation 216 is assigned to the agent 116 and an initial task allocation 218 is assigned to the agent 120. Although not illustrated, an initial task allocation is assigned to the additional agents 124.

In more detail, the allocation initialization module 126 is responsible for the initial distribution of the set of tasks 102 among the set of agents 114. This module calculates an initial task allocation that optimizes both individual agent costs and overall team performance. The module uses the dynamic weight calculation 202, which adjusts the importance of these objectives in real-time based on contextual factors such as deadlines, task complexity, and agent capabilities.

Let T={T₁, T₂, . . . , Tₘ}represent the set of tasks 102, and A={A₁, A₂, . . . , Aₙ}represent the set of agents 114. The cost function for an agent Aᵢ when assigned a task Tⱼ is denoted by Cᵢⱼ, which reflects the effort, time, and resources required by Aᵢ to complete Tⱼ.

The minimized cost function 208 for the initial allocation is given by:

$$Minimize {\sum }_{i = 1}^{n} {\sum }_{j = 1}^{m} {w}_{i j} ( t ) \cdot {C}_{i j} \cdot {x}_{i j} , \qquad ( 1 )$$

where xᵢⱼ∈{0,1}indicates whether task Tⱼ is assigned to agent Aᵢ, and wᵢⱼ(t) is the dynamic weight 204 assigned to the cost based on real-time contextual factors at time t.

The dynamic weight 204 wᵢⱼ(t) is computed as:

$${w}_{i j} ( t ) = α \cdot Urgency ( {T}_{j} , t ) + β \cdot Complexity ( {T}_{j} ) + γ \cdot Capability ( {A}_{i} , {T}_{j} ) \qquad ( 2 )$$

where α, β, and γ are the tunable factors 204A that determine the influence of each factor. The system continuously adjusts these weights as the context evolves, ensuring that the initial allocation is as optimal as possible given the current conditions. The output of allocation initialization module 126 is the initial task allocations 212, which serve as the input for at least some the subsequent modules of the task allocation and negotiation system 100.

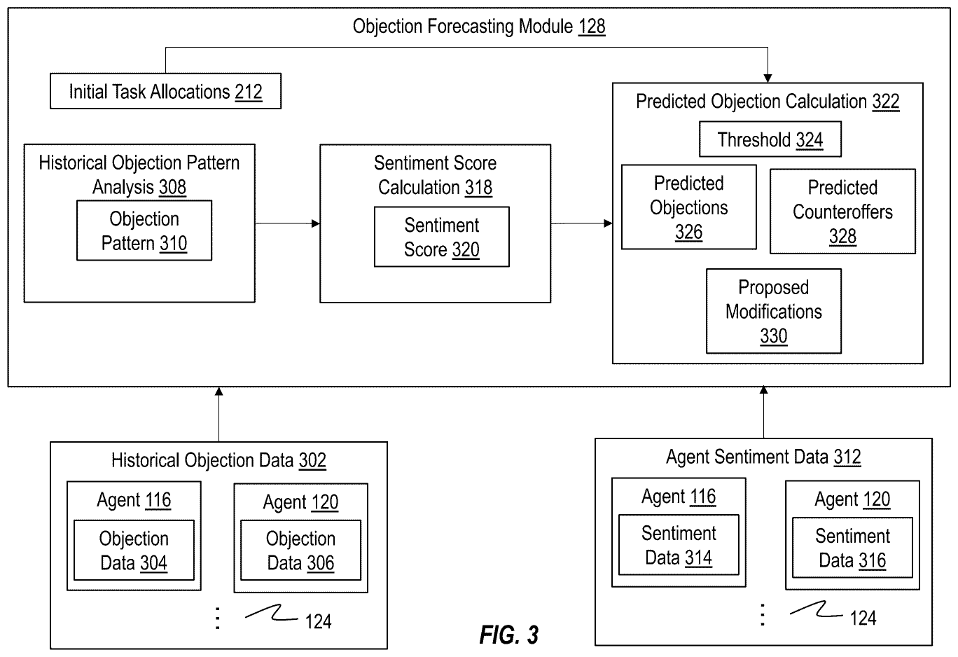

FIG. 3 illustrates an embodiment of the objection forecasting module 128 and its operation. As illustrated, the objection forecasting module 128 receives or otherwise accesses historical objection data 302 for each agent. The historical objection data 302 specifies past objections to performing a given task or set of tasks raised by the agents 116, 120, and 124 when being assigned an initial task allocation similar to the task allocations 216 and 218. For example, the historical objection data 302 includes objection data 304 associated with the agent 116 that specifies the specific objections of the agent 116 and objection data 306 associated with the agent 120 that specifies the specific objections of the agent 120. Although not illustrated, the historical objection data 302 includes objection data associated with the additional agents 124. In some embodiments there can be instances when the historical objection data 302 for a given agent includes no data in cases where the agent has never worked on a task similar to the tasks in the initial task allocation 212 or has never raised an objection when working on a task similar to the tasks in the initial task allocation 212. In the case of agents that are computing resources such as CPUs and GPUs, the historical objection data 302 may be data related to their historical performance when performing an initial task allocation similar to the task allocations 216 and 218.

The historical objection data 302 is then used by the objection forecasting module 128 to perform historical objection pattern analysis 308. This results in a determination of an objection pattern 310 for each of the agents when being assigned an initial task allocation similar to the task allocations 216 and 218. The objection pattern 310 for each agent is then used in predicting objections that might be raised by the agents as will be explained.

The objection forecasting module 128 also receives or otherwise accesses agent sentiment data 312 for each agent. The agent sentiment data 312 is data that specifies the current sentiment, which can include current feelings or current conditions, of the agents 116, 120, and 124 about being assigned the initial task allocations 216 and 218. For example, the agent sentiment data 312 includes sentiment data 314 associated with the agent 116 that specifies the current sentiment of the agent 116 and sentiment data 316 associated with the agent 120 that specifies the current sentiment of the agent 120. Although not illustrated, the agent sentiment data 312 includes sentiment data associated with the additional agents 124.

In some embodiments the agent sentiment data 312 is collected from current sources such as social media, chats, texts or the like of the agents 116, 120, or 124. In other embodiments, the agent sentiment data 312 may be directly collected from the agent as the agent directly inputs their current sentiment into the objection forecasting module 128 or as the agent specific their current sentiment to their project manager or the like. In still other embodiments, the agent sentiment data 312 can be collected from both the current sources and the agent themselves. Thus, the agent sentiment data 312 specifies the current conditions and feelings of the agents about being assigned the initial task allocations 212. In the case of agents that are computing resources such as CPUs and GPUs, the agent sentiment data 312 may be data related to their current conditions such as current workload and remaining available computing resources.

The agent sentiment data 312 is then used by the objection forecasting module 128, in conjunction with the objection pattern 310 of each agent, to perform a sentiment score calculation 318, which can include training a sentiment analysis ML model. This results in a determination of a sentiment score 320 for each of the agents when being assigned the initial task allocations 216 and 218. The sentiment score 320 for each agent is then used in predicting objections that might be raised by the agents as will be explained.

The objection forecasting module 128 uses the objection pattern 310 and sentiment score 320 for each agent and the initial task allocations 212 to perform a predicted objection calculation 322. The result of this calculation is a set of predicted objections 326 for each agent and predicted counteroffers (also referred to as counterfactuals) 328 that the given agent might propose in response to their initial objection. In addition, the objection forecasting module 128 provides proposed modifications to the initial task allocations 212 to preemptively address likely objections. The predicted objections 326, the predicted counteroffers 328, and the proposed modifications 330 are then used by other modules of the task allocation and negotiation system 100 as will be explained in more detail to follow.

In more detail, objection forecasting module 128 is configured to anticipate potential objections from agents 116, 120, and 124 regarding the initial task allocations 212. This module leverages historical objection data 302 and agent sentiment data 312 to predict objections by agents and counteroffers that agents might propose. By forecasting these objections 326, the objection forecasting module 128 can preemptively address potential conflicts, enhancing both efficiency and agent satisfaction.

The objection forecasting module 128 includes sentiment-driven forecasting, which integrates sentiment analysis into the objection prediction process. Historical objection data on agent interactions, including past objections, resolutions, and feedback, is used to train a sentiment analysis model.

Let Sentiment (Aᵢ, t) denote the sentiment score 320 of agent Aᵢ at time t, derived from their previous interactions. The probability that agent Aᵢ will object to the initial allocation is given by:

$$P ( {Objection}_{ij} ) = f ( Sentiment ( {A}_{i} , t ) , {Allocation}_{ij} , HistoricalObjections ( {A}_{i} ) ) , \qquad ( 3 )$$

If P(Objectionᵢⱼ) exceeds a predefined threshold 324, the system proactively considers alternative allocations or prepares justification strategies to address the predicted objection. The output of the objection forecasting module 128 includes: predicted objections 326 from agents, predicted counteroffers 328 from agents, and proposed modifications 330 to the initial allocation to preemptively address likely objections.

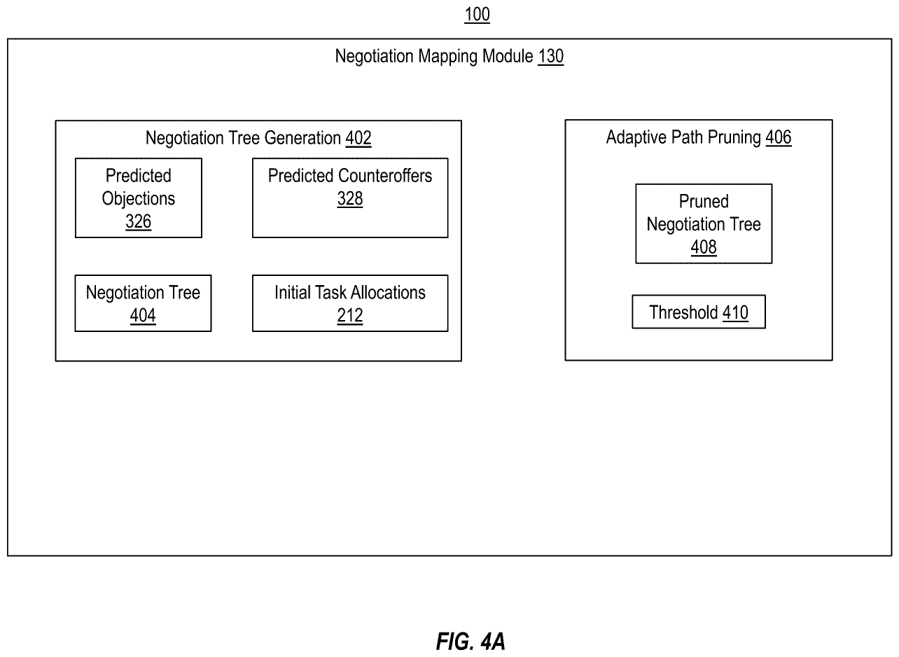

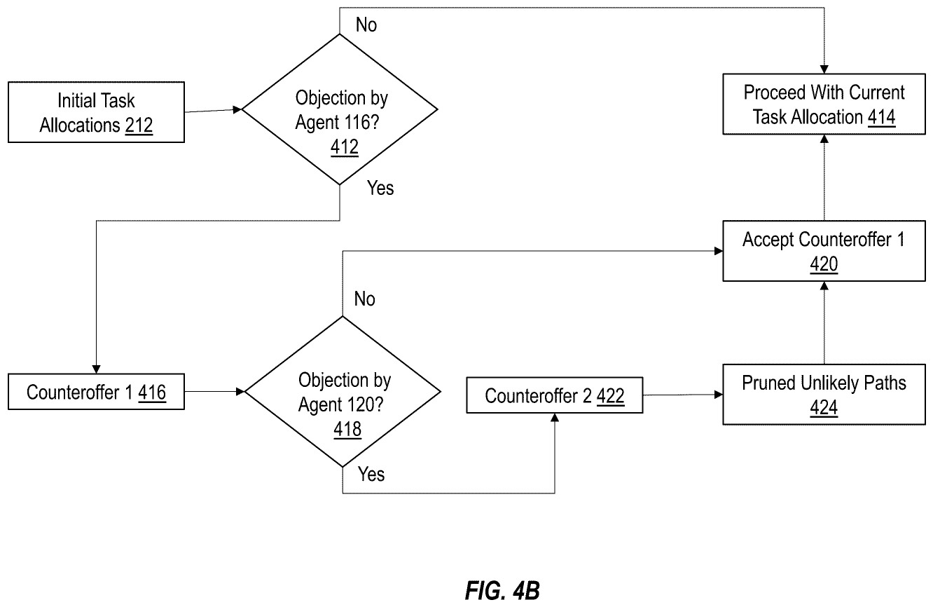

FIGS. 4A and 4B illustrate an embodiment of the negotiation mapping module 130 and its operation. As illustrated, the negotiation mapping module 130 receives or otherwise accesses the initial task allocations 212, the predicted objections 326, and the predicted counteroffers 328. The negotiation mapping module 130 then performs negotiation tree generation 402 to generate a negotiation tree 404. The negotiation mapping module 130 further performs adaptive path pruning 406 on the negotiation tree 404 to generate a pruned negotiation tree 408.

In more detail, the negotiation mapping module 130 is responsible for constructing the negotiation tree 404 that outlines potential negotiation paths based on the predicted objections 326 and predicted counteroffers 328. The negotiation tree 404 is used for modeling a negotiation process, allowing the negotiation mapping module 130 to anticipate and prepare for various negotiation scenarios.

In some embodiments, the negotiation tree 404 is represented as a directed acyclic graph (DAG), where each node corresponds to a specific task allocation and each edge represents a potential counteroffer or rejection by an agent. The negotiation tree 404 begins with the initial allocations 212 and branches out based on predicted counteroffers 328 that agents might propose.

As previously mentioned, the negotiation mapping module 130 performs the adaptive path pruning 406. As the negotiation tree 404 can grow exponentially with the number of agents and tasks, this mechanism dynamically prunes unlikely negotiation paths in real-time, focusing computational resources on the most probable and relevant scenarios.

The probability of a path being followed is calculated using a combination of the predicted objections 326 probabilities from the previous module and the cost-benefit analysis of predicted counteroffers 328. Let P(Pathₖ) denote the probability of following path k in the negotiation tree 404, and Cₖ the associated cost:

$$P ( {Path}_{k} ) = {\prod }_{i ∈ A} P ( {Objection}_{ij} ) \cdot P ( {Counteroffer}_{ik} ) \qquad ( 5 )$$

where P(Objectionᵢⱼ) is the probability of an objection by agent Aᵢ, and P(Counterofferᵢₖ) is the probability of agent Aᵢ proposing a counteroffer leading to path k. Paths with P(Pathₖ)<ϵ, where ϵ is a predefined threshold 410, which in some embodiments is the same as predefined threshold 324, are pruned, reducing the complexity of the negotiation tree 404, where the predefined threshold 410 specifies an acceptable probability value. The result of the path pruning is the pruned negotiation tree 408 that focuses on the most likely negotiation paths, allowing the negotiation mapping module 130 to efficiently navigate complex negotiations.

FIG. 4B illustrates an embodiment of an operational process of the negotiation mapping module 130 in generating the negotiation tree 404 and the pruned negotiation tree 408. As illustrated, the initial task allocations 212 are input into the negotiation mapping module 130. At a decision block 412, it is determined if there is a predicted objection by agent 116 to the initial task allocations 212. If the there is not a predicted objection by agent 116 (No at decision block 412), the negotiation mapping module 130 will proceed with the current task allocation as shown at 414, which in the initial iteration will be the initial task allocations 212.

However, if there is a predicted objection by the agent 116 (Yes at decision block 412), a predicted counteroffer 1 is determined at 416. At a decision block 418, it is determined if there is a predicted objection by the agent 120 to the predicted counteroffer 1. If the there is no predicted objection by agent 120 (No at decision block 418), the counteroffer 1 is accepted as shown at 420 and the negotiation mapping module 130 will proceed with the current task allocation as shown at 414, which will be the initial task allocations according to the counteroffer 1.

However, if there is a predicted objection by the agent 120 (Yes at decision block 418), a predicted counteroffer 2 is determined at 422. In the embodiment, the path for the agent 116 to accept the counteroffer 2 has a low probability of happening as this path is less than the predefined threshold 410, and so the path is pruned by the adaptive path pruning as shown at 424 and the flow reverts to accepting the counteroffer 1. This process is repeated as needed until all unlikely paths are pruned and the resulting pruned negotiation tree 408 is generated.

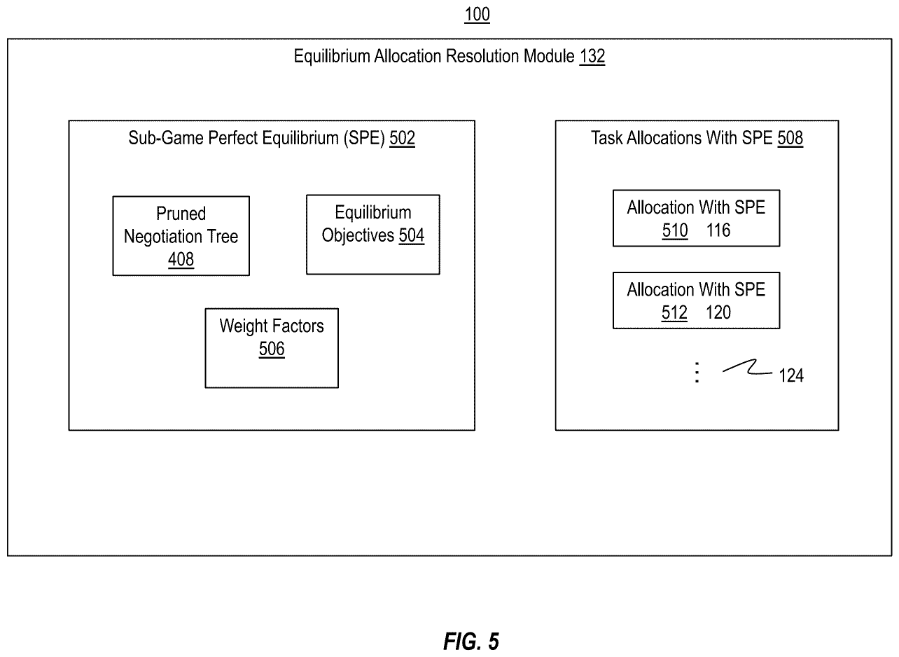

FIG. 5 illustrates an embodiment of the equilibrium allocation resolution module 132 and its operation. In operation, the equilibrium allocation resolution module 132 determines an optimal task allocation that will at least attempt to satisfy all of the agents 116, 120, and 124. The equilibrium allocation resolution module 132 utilizes the concept of Sub-game Perfect Equilibrium (SPE) 502 to find a solution that is stable and acceptable to all agents, given the negotiation paths explored in the negotiation mapping module 130.

The SPE 502 is identified using a backward induction process applied to the pruned negotiation tree 408. The goal is to ensure that no agent can improve their outcome by deviating from the proposed task allocation, considering the potential responses of other agents.

Backward induction begins at the leaves of the pruned negotiation tree 408 and proceeds backward to the root, determining the optimal decision at each node. Let oₖ denote the allocation at node k, and Cᵢ(oₖ) represent the cost to agent Aᵢ for allocation oₖ.

The SPE 502 is found by solving the following recursive equation:

$${V}_{k} = {min}_{{o}_{k}} [ {C}_{i} ( {o}_{k} ) + {\sum }_{j ∈ Children ( k )} P ( {Path}_{j} ) \cdot {V}_{j} ] , \qquad ( 6 )$$

where Vₖ is the value of node k, which represents the minimum possible cost for the agent at that node, and Children (k) are the child nodes of k in the pruned negotiation tree 408. The process ensures that at every node, the allocation that minimizes an agent's cost, given the probable future decisions, is selected.

In addition to minimizing cost, the equilibrium allocation resolution module 132 enhances the equilibrium selection by considering multiple equilibrium objectives 504 such as, but not limited to, fairness, agent satisfaction, and task criticality. The final SPE 502 is selected not only based on cost minimization but also by optimizing these additional criteria.

Let F(oₖ) represent the fairness score, S(oₖ) the agent satisfaction, and R(oₖ) the task criticality for allocation oₖ. The final objective function is:

$$Maximize {\sum }_{k ∈ Nodes} [ {λ}_{1} \cdot F ( {o}_{k} ) + {λ}_{2} \cdot S ( {o}_{k} ) + {λ}_{3} \cdot R ( {o}_{k} ) ] , \qquad ( 7 )$$

where λ₁, λ₂, and λ₃ are weight factors 506 that can be adjusted according to the importance of each criterion.

The output of the equilibrium allocation resolution module 132 is the final task allocation that represents the SPE 502, optimized for multiple equilibrium objectives 504, ensuring a balanced and fair outcome for all agents involved. For example, the equilibrium allocation resolution module 132 outputs task allocations with SPE 508 for each of the agents. As illustrated, a task allocation with SPE 510 is assigned to the agent 116 and a task allocation with SPE 512 is assigned to the agent 120. Although not illustrated, a task allocation with SPE is assigned to the additional agents 124.

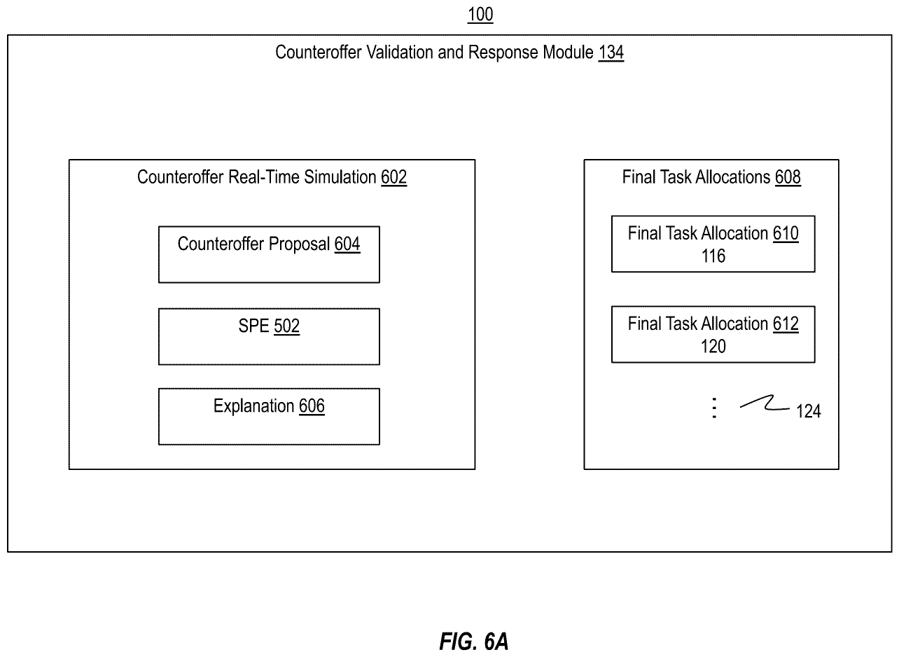

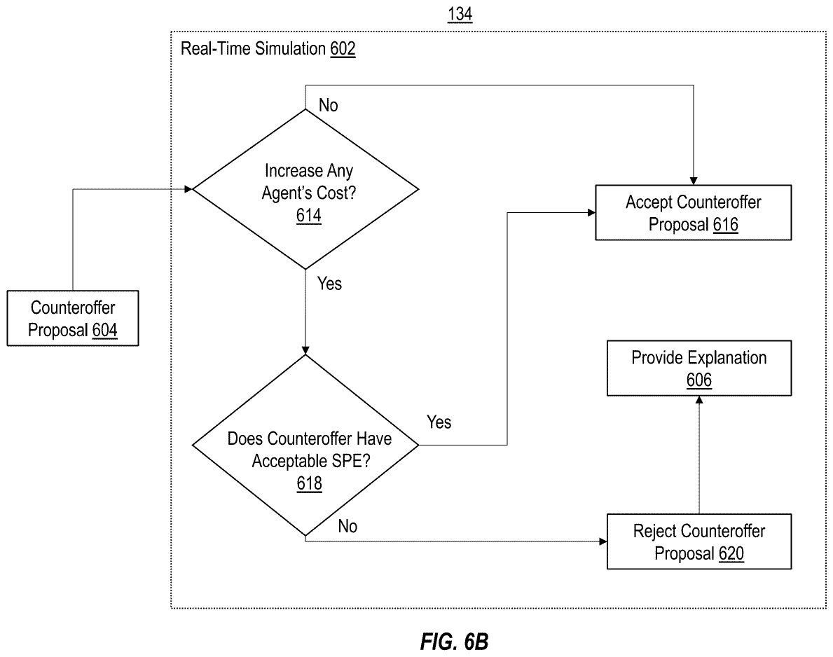

FIGS. 6A and 6B illustrate an embodiment of the counteroffer validation and response module 134 and its operation. As illustrated, the counteroffer validation and response module 134 performs counteroffer real-time simulation 602 on a counteroffer proposal 604 for an alternative task allocation that is received from one of the agents 116, 120, and 124. The counteroffer proposal 604 is an actual counteroffer and not a predicted counteroffer as previously described. The purpose of the counteroffer proposal 604 is to allow an agent the chance to propose a task allocation that may have been missed by the task allocation and negotiation system 100 when generating the pruned negotiation tree 408 or that the agent feels is superior to the task allocation generated by the task allocation and negotiation system 100. In this way, the experience and preferences of each of the agents is taken into account when making the final task allocation.

The counteroffer proposal 604 is simulated in real-time against the SPE 502. If the counteroffer proposal 604 still leads to an acceptable SPE 502, it is accepted, but if it leads to an unacceptable SPE 502, it is rejected. An explanation 606 is then provided to the agent who provided the counteroffer proposal 604.

In more detail, when the counteroffer proposal 604 is received from one of the agents 116, 120, or 124, the counteroffer validation and response module 134 runs the real-time simulation 602 to assess the feasibility and impact of the proposed new task allocation specified in the counteroffer proposal 604. This involves re-evaluating the pruned negotiation tree 408 with the new task allocation as a potential starting point and determining how this would affect the costs and outcomes for all agents involved.

Let o* be the task allocations with SPE 508, and o′ be the task allocation proposed by agent Aᵢ in the counteroffer proposal 604. The counteroffer validation and response module 134 computes the expected change in cost for all agents using the following equation:

$$Δ {C}_{i} = {C}_{i} ( {o}^{′} ) - {C}_{i} ( {o}^{*} ) \qquad ( 8 )$$

where Cᵢ(o′) is the cost for agent Aᵢ under the task allocation proposed in the counteroffer proposal 604, and Cᵢ(o*) is the cost under the task allocations with SPE 508. If ΔCᵢ>0 for any agent, meaning that the task allocation proposed in the counteroffer proposal 604 increases the cost for that agent, the counteroffer validation and response module 134 evaluates whether the task allocation proposed in the counteroffer proposal 604 still leads to an acceptable Sub-game Perfect Equilibrium (SPE) 502. If not, the task allocation proposed in the counteroffer proposal 604 is rejected, and the task allocation with SPE 508 is maintained.

FIG. 6B illustrates an embodiment of an operational process of the counteroffer validation and response module 134 when performing the real-time simulation 602. As illustrated, the counteroffer proposal 604 is received from agent 116 and the real-time simulation 602 is performed. At a decision block 614, it is determined if the counteroffer proposal 604 will increase the costs of any of the agents 116, 120, and 124. If it is determined that there is no cost increase for any of the agents 116, 120, and 124 (No in decision block 614), the counteroffer proposal 604 is accepted as shown at 616.

If it is determined that there is a cost increase for any of the agents 116, 120, and 124 (Yes in decision block 614), it is then determined at decision block 618 if the counteroffer proposal 604 has an acceptable SPE 502. If it is determined that that the counteroffer proposal 604 does have an acceptable SPE 502 (Yes in decision block 618), the counteroffer proposal 604 is accepted as shown at 616.

If it is determined that it is determined that that the counteroffer proposal 604 does not have an acceptable SPE 502 (No in decision block 618), the counteroffer proposal 604 is rejected as shown at 620. In such case, the explanation 606 of why the counteroffer proposal 604 was rejected is provided to agent 116.

The counteroffer validation and response module 134 outputs a final task allocation based on whether the counteroffer proposal 604 was accepted or rejected. For example, the counteroffer validation and response module 134 outputs final task allocations 608 for each of the agents. As illustrated, a final task allocation 610 is assigned to the agent 116 and a final task allocation 612 is assigned to the agent 120. Although not illustrated, a final task allocation is assigned to the additional agents 124. In those embodiments where the counteroffer proposal 604 is accepted, the final task allocations 608 will include the task allocation specified in the counteroffer proposal 604. In those embodiments where the counteroffer proposal 604 is rejected, the final task allocations 608 will be the same as the task allocations with SPE 508.

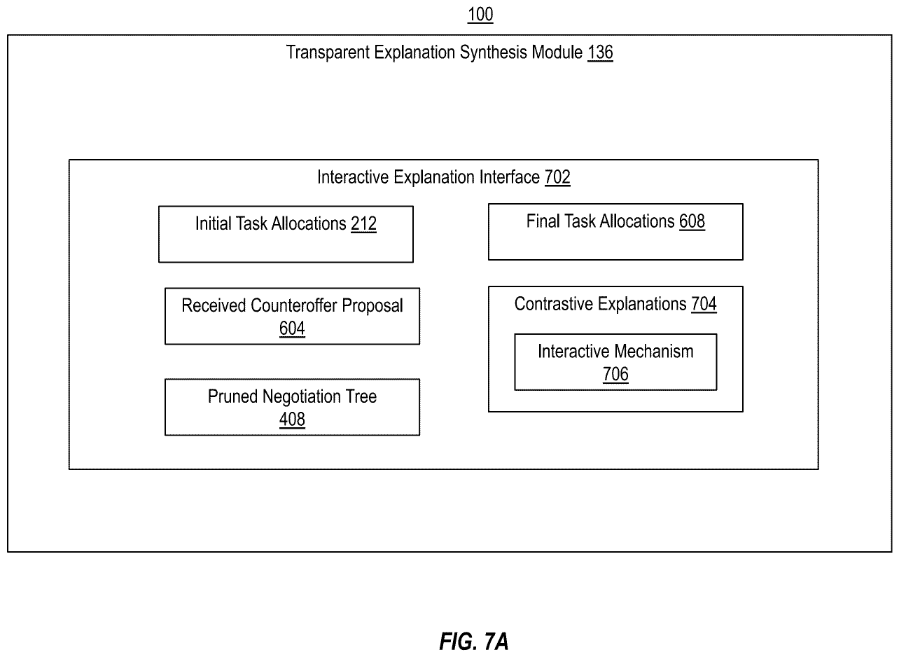

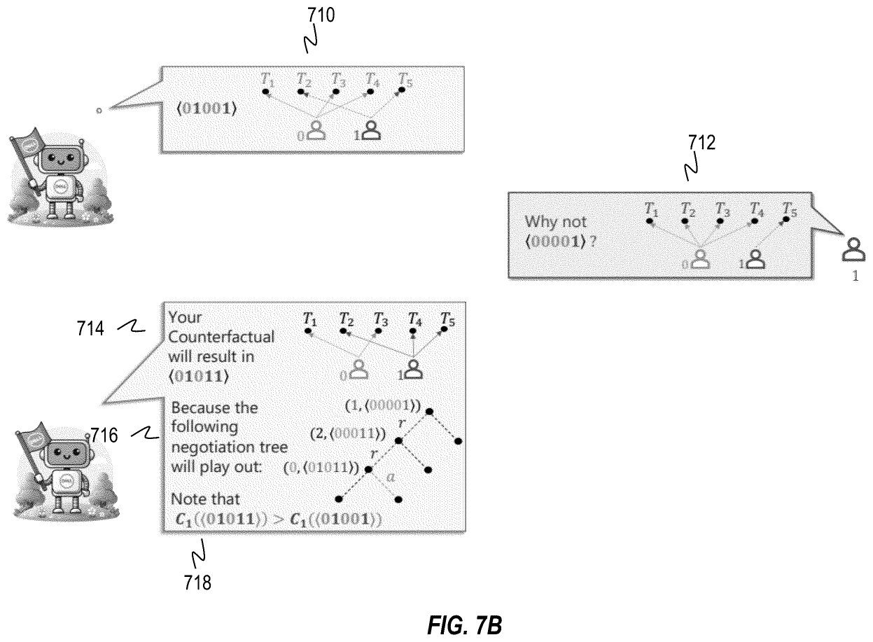

FIGS. 7A and 7B illustrate an embodiment of the transparent explanation synthesis module 136 and its operation. The transparent explanation synthesis module 136 provides the agents 116, 120, and 124 with clear and comprehensible explanations for the final task allocations 608. The transparent explanation synthesis module 136 enhances transparency by allowing the agents 116, 120, and 124 to explore the reasoning behind the task allocation and negotiation system 100's decisions, including the consideration of any counteroffer proposals 604.

As illustrated in FIG. 7A, the transparent explanation synthesis module 136 includes an interactive explanation interface 702 which visualizes the negotiation tree and the decision-making process in a user-friendly manner. Agents 116, 120, and 124 can interact with the interactive explanation interface 702 to explore different branches of the pruned negotiation tree 408, see the outcomes of various scenarios, and understand why certain decisions were made.

As illustrated, the interactive explanation interface 702 illustrates various elements
The original task allocations 212 and its associated costs.
The pruned negotiation tree 408 and the explanation of how final result of the negation tree was determined.
Counteroffer proposals 604 and the resulting changes in allocation and costs.
The final task allocations 608, including the Sub-game Perfect Equilibrium (SPE) that was reached

The interactive explanation interface 702 also provides textual explanations that summarize the decision making process, offering insights into why the final task allocations 608 was found to be preferable or why the counteroffer proposal 604 was rejected.

To further enhance understanding, the transparent explanation synthesis module 136 generates contrastive explanations 704, which are displayed in the interactive explanation interface 702, that explicitly compare the final task allocations 608 with any rejected counteroffer proposal 604. This is achieved by highlighting the differences in outcomes and explaining why the final task allocations 608 leads to a more favorable result.

Let o* be the final task allocations 608, and o′ be the task allocation proposed by agent Aᵢ in the counteroffer proposal 604. The contrastive explanation focuses on the difference in agent costs:

$$Difference = {\sum }_{i = 1}^{n} [ {C}_{i} ( {o}^{*} ) - {C}_{i} ( {o}^{′} ) ] \qquad ( 9 )$$

where Cᵢ(o′) is the cost for agent Aᵢ under the task allocation proposed in the counteroffer proposal 604, and Cᵢ(o*) is the cost under the final task allocations 608. The explanation highlights these differences and provides a rationale for why the final task allocations 608 was chosen over the task allocations specified in the counteroffer proposal 604, emphasizing fairness, efficiency, and overall team performance.

In some embodiments, the contrastive explanations 704 are based on an interactive mechanism 706 that allows agents 116, 120, and 124 to explore the consequences of their counteroffer proposals 604. Agents 116, 120, and 124 can view how their proposed changes would affect the overall allocation and costs for all parties involved.

The interactive mechanism 706 visualizes the pruned negotiation tree 408 from the perspective of the task allocation specified in the counteroffer proposals 604, highlighting potential paths and outcomes. Agents 116, 120, and 124 can see in real-time why their counteroffer proposals 604 might be rejected or accepted and how it compares to the current task allocation.

FIG. 7B illustrates the operation of the interactive explanation interface 702. As shown at 710, the interactive explanation interface 702 shows a task allocation for an agent 0 and an agent 1. As illustrated, the agent 0 is assigned tasks T1, T2, and T4 and agent 1 is assigned tasks T2 and T5. As shown at 712, the interactive explanation interface 702 shows a counteroffer proposal from agent 1 that proposes a task allocation that assigns tasks T1-T4 to agent 0 and only task T5 to agent 1.

As shown at 714, the interactive explanation interface 702 shows the result of the counteroffer proposal from agent 1, which is that tasks T1 and T3 will be assigned to agent 0 and tasks T2, T4, and T5 will be assigned to agent 1. As shown at 716, the interactive explanation interface 702 explains that the result of the counteroffer proposal from agent 1 is based on a negotiation tree that is generated and iteratively analyzed by the various modules of the task allocation and negotiation system 100 based on the predicted objections and predicted and actual counteroffers by the various agents in the manner previously described. As shown at 718, the interactive explanation interface 702 explains that the cost to agent 1 of the task allocation that results from their counteroffer proposal is higher than the task allocation shown at 710. Thus, in this case the task allocation that results from their counteroffer proposal would be rejected. Thus, the output of the transparent explanation synthesis module 136 is an interactive and contrastive explanation that not only justifies the final allocation but also builds trust among agents by providing transparency in the decision-making process.

### Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

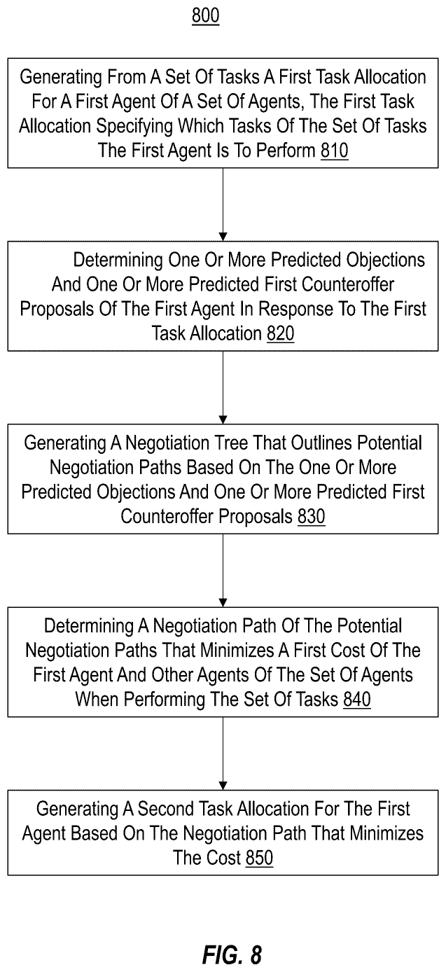

Directing attention now to FIG. 8, an example method 800 is disclosed. The method 800 will be described in relation to one or more of the figures previously described, although the method 800 is not limited to any particular embodiment.

The method 800 includes generating from a set of tasks a first task allocation for a first agent of a set of agents, the first task allocation specifying which tasks of the set of tasks the first agent is to perform (810). For example, as previously described the allocation initialization module 126 generates the initial task allocations 212 including the task allocation 216 for agent 116 and task allocation 218 for agent 120 from the set of tasks 102.

The method 800 includes determining one or more predicted objections and one or more predicted first counteroffer proposals of the first agent in response to the first task allocation (820). For example, as previously described the objection forecasting module 128 determines the predicted objections 326 and the predicted counteroffers 328. In some embodiments, this is based on the historical objection data 302 and the agent sentiment data 312 as previously described.

The method 800 includes generating a negotiation tree that outlines potential negotiation paths based on the one or more predicted objections and one or more predicted first counteroffer proposals (830). For example, as previously described the negotiation mapping module 130 generates the negotiation tree 404. Adaptive path pruning 406 is applied to the negotiation tree 404 to prune unlikely paths to generate the pruned negotiation tree 408 in the manner previously described.

The method 800 includes determining a negotiation path of the potential negotiation paths that minimizes a first cost of the first agent and other agents of the set of agents when performing the set of tasks (840). For example, as previously described the equilibrium allocation resolution module 132 uses the Sub-game Perfect Equilibrium (SPE) 502 to find a solution that is stable and acceptable to all agents, given the negotiation paths explored in the negotiation mapping module 130, by determining the negotiation path that minimizes a first cost of the agent in performing the task allocations.

The method 800 includes generating a second task allocation for the first agent based on the negotiation path that minimizes the cost (850). For example, as previously described the counteroffer validation and response module 134 generates final task allocations 608 including the final task allocation 610 for the agent 116 and the final task allocation 612 for the agent 120. In those embodiments where any counteroffer proposals 604 are either not accepted or are not provided, then the final task allocations 608 is the same as the task allocations with SPE 508. In those embodiments where any counteroffer proposals 604 are accepted, then the final task allocations 608 reflect the acceptance of the counteroffer proposals.

### Further Example Embodiments

Following are some further example embodiments of the invention. These are presented only by way of example and are not intended to limit the scope of the invention in any way.

Embodiment 1. A method comprising: generating from a set of tasks a first task allocation for a first agent of a set of agents, the first task allocation specifying which tasks of the set of tasks the first agent is to perform; determining one or more predicted objections and one or more predicted first counteroffer proposals of the first agent in response to the first task allocation; generating a negotiation tree that outlines potential negotiation paths based on the one or more predicted objections and one or more predicted first counteroffer proposals; determining a negotiation path of the potential negotiation paths that minimizes a first cost of the first agent and other agents of the set of agents when performing the set of tasks; and generating a second task allocation for the first agent based on the negotiation path that minimizes the cost.

Embodiment 2. The method as recited in embodiment 1, further comprising: reporting to the first agent the second task allocation via an interactive interface that provides an explanation about how the second task allocation was generated.

Embodiment 3. The method as recited in any of embodiments 1-2, further comprising: receiving a second counteroffer proposal from the first agent; determining during a real-time simulation, based on the second counteroffer proposal, a second cost of the first agent and the other agents of the set of agents when performing the set of tasks; determining if the second cost is less than the first cost; and in response to determining that the second cost is less than the first cost, accepting the second counteroffer proposal and using the second counteroffer proposal when generating the second task allocation.

Embodiment 4. The method as recited in any of embodiments 1-3, wherein generating the first task allocation comprises: determining a dynamic weight based on one or more task factors and one or more agent capabilities; and using the dynamic weight in determining the tasks of the set of tasks that are to be included in the first allocation.

Embodiment 5. The method as recited in embodiment 4, wherein the one or more task factors include complexity of the task and a time limit for completing the task and the one or more agent capabilities include experience of the first agent or resource availability of the first agent.

Embodiment 6. The method as recited in any of embodiments 1-5, wherein the one or more predicted objections and one or more predicted first counteroffers are based on one or more of historical objection data and agent sentiment data.

Embodiment 7. The method as recited in any of embodiments 1-6, wherein generating a negotiation tree that outlines potential negotiation paths based on the one or more predicted objections and one or more predicted first counteroffer proposals comprises: pruning those potential negotiation paths having a probability that is less than a predefined threshold, the probability being indicative of the potential negotiation paths not minimizing the first cost.

Embodiment 8. The method as recited in any of embodiments 1-7, wherein determining a negotiation path of the potential negotiation paths that minimizes a first cost of the first agent and other agents of the set of agents when performing the set of tasks comprises: determining a sub-game perfect equilibrium (SPE) when determining the negotiation path that minimizes the cost.

Embodiment 9. The method as recited in embodiment 8, wherein the SPE is determined based on one or more equilibrium factors including one or more of fairness score, agent satisfaction, and task criticality.

Embodiment 10. The method as recited in any of embodiments 1-9, wherein the first agent is one of a human agent or a CPU or GPU.

Embodiment 11. A computing system for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-11.

### Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

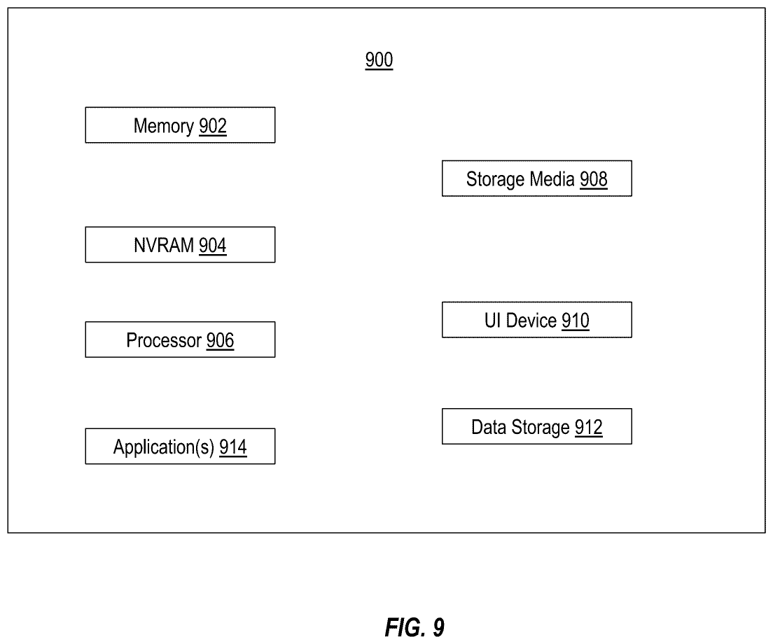

With reference briefly now to FIG. 9, any one or more of the entities disclosed, or implied, by FIGS. 1-9 and/or elsewhere herein, may take the form of, or include, or be implemented on, or hosted by, a physical computing device, one example of which is denoted at 900. As well, where any of the aforementioned elements comprise or consist of a virtual machine (VM), that VM may constitute a virtualization of any combination of the physical components disclosed in FIG. 9.

In the example of FIG. 9, the physical computing device 900 includes a memory 902 which may include one, some, or all, of random access memory (RAM), non-volatile memory (NVM) 904 such as NVRAM for example, read-only memory (ROM), and persistent memory, one or more hardware processors 906, non-transitory storage media 908, UI device 910, and data storage 912. One or more of the memory components 902 of the physical computing device 904 may take the form of solid state device (SSD) storage. As well, one or more applications 914 may be provided that comprise instructions executable by one or more hardware processors 906 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The described embodiments are to be considered in all respects only as illustrative and not restrictive. All changes which come within the meaning and range of equivalency of the claims are to be embraced within their scope.

What is claimed is:

1. A method, comprising:
generating from a set of tasks a first task allocation for a first agent of a set of agents, the first task allocation specifying which tasks of the set of tasks the first agent is to perform;
determining one or more predicted objections and one or more predicted first counteroffer proposals of the first agent in response to the first task allocation;
generating a negotiation tree that outlines potential negotiation paths based on the one or more predicted objections and one or more predicted first counteroffer proposals;
determining a negotiation path of the potential negotiation paths that minimizes a first cost of the first agent and other agents of the set of agents when performing the set of tasks; and
generating a second task allocation for the first agent based on the negotiation path that minimizes the cost.

2. The method of claim 1, further comprising:
reporting to the first agent the second task allocation via an interactive interface that provides an explanation about how the second task allocation was generated.

3. The method of claim 1, further comprising:
receiving a second counteroffer proposal from the first agent;
determining during a real-time simulation, based on the second counteroffer proposal, a second cost of the first agent and the other agents of the set of agents when performing the set of tasks;
determining if the second cost is less than the first cost; and
in response to determining that the second cost is less than the first cost, accepting the second counteroffer proposal and using the second counteroffer proposal when generating the second task allocation.

4. The method of claim 1, wherein generating the first task allocation comprises:
determining a dynamic weight based on one or more task factors and one or more agent capabilities; and
using the dynamic weight in determining the tasks of the set of tasks that are to be included in the first allocation.

5. The method of claim 4, wherein the one or more task factors include complexity of the task and a time limit for completing the task and the one or more agent capabilities include experience of the first agent or resource availability of the first agent.

6. The method of claim 1, wherein the one or more predicted objections and one or more predicted first counteroffers are based on one or more of historical objection data and agent sentiment data.

7. The method of claim 1, wherein generating a negotiation tree that outlines potential negotiation paths based on the one or more predicted objections and one or more predicted first counteroffer proposals comprises:
pruning those potential negotiation paths having a probability that is less than a predefined threshold, the probability being indicative of the potential negotiation paths not minimizing the first cost.

8. The method of claim 1, wherein determining a negotiation path of the potential negotiation paths that minimizes a first cost of the first agent and other agents of the set of agents when performing the set of tasks comprises:
determining a sub-game perfect equilibrium (SPE) when determining the negotiation path that minimizes the cost.

9. The method of claim 8, wherein the SPE is determined based on one or more equilibrium factors including one or more of fairness score, agent satisfaction, and task criticality.

10. The method of claim 1, wherein the first agent is one of a human agent or a CPU or GPU.

11. A non-transitory storage medium having stored therein instructions that are executable by one or more hardware processors to perform operations comprising:
generating from a set of tasks a first task allocation for a first agent of a set of agents, the first task allocation specifying which tasks of the set of tasks the first agent is to perform;
determining one or more predicted objections and one or more predicted first counteroffer proposals of the first agent in response to the first task allocation;
generating a negotiation tree that outlines potential negotiation paths based on the one or more predicted objections and one or more predicted first counteroffer proposals;
determining a negotiation path of the potential negotiation paths that minimizes a first cost of the first agent and other agents of the set of agents when performing the set of tasks; and
generating a second task allocation for the first agent based on the negotiation path that minimizes the cost.

12. The non-transitory storage medium of claim 11, further comprising:
reporting to the first agent the second task allocation via an interactive interface that provides an explanation about how the second task allocation was generated.

13. The non-transitory storage medium of claim 11, further comprising:
receiving a second counteroffer proposal from the first agent;
determining during a real-time simulation, based on the second counteroffer proposal, a second cost of the first agent and the other agents of the set of agents when performing the set of tasks;
determining if the second cost is less than the first cost; and
in response to determining that the second cost is less than the first cost, accepting the second counteroffer proposal and using the second counteroffer proposal when generating the second task allocation.

14. The non-transitory storage medium of claim 11, wherein generating the first task allocation comprises:
determining a dynamic weight based on one or more task factors and one or more agent capabilities; and
using the dynamic weight in determining the tasks of the set of tasks that are to be included in the first allocation.

15. The non-transitory storage medium of claim 14, wherein the one or more task factors include complexity of the task and a time limit for completing the task and the one or more agent capabilities include experience of the first agent or resource availability of the first agent.

16. The non-transitory storage medium of claim 11, wherein the one or more predicted objections and one or more predicted first counteroffers are based on one or more of historical objection data and agent sentiment data.

17. The non-transitory storage medium of claim 11, wherein generating a negotiation tree that outlines potential negotiation paths based on the one or more predicted objections and one or more predicted first counteroffer proposals comprises:
pruning those potential negotiation paths having a probability that is less than a predefined threshold, the probability being indicative of the potential negotiation paths not minimizing the first cost.

18. The non-transitory storage medium of claim 11, wherein determining a negotiation path of the potential negotiation paths that minimizes a first cost of the first agent and other agents of the set of agents when performing the set of tasks comprises:
determining a sub-game perfect equilibrium (SPE) when determining the negotiation path that minimizes the cost.

19. The non-transitory storage medium of claim 18, wherein the SPE is determined based on one or more equilibrium factors including one or more of fairness score, agent satisfaction, and task criticality.

20. The non-transitory storage medium of claim 11, wherein the first agent is one of a human agent or a CPU or GPU.
